(19) United States
(12) Patent Application Publication
(10) Pub. No.: US 2020/0284264 A1
(43) Pub. Date: Sep. 10, 2020

(54) Ring-Shaped Light Fan

(71) Applicant: Dongguan Jianxin Electronic Technology Co., Ltd., Dongguan (CN)

(72) Inventor: Haoqiang Deng, Dongguan (CN)

(21) Appl. No.: 16/577,635

(22) Filed: Sep. 20, 2019

(30) Foreign Application Priority Data
Mar. 7, 2019 (CN) 201920293879.1

(51) Int. Cl. F04D 19/00; F21V 33/00

(52) U.S. Cl. CPC F04D 19/002; F21Y 2115/10; F21V 33/0096

(57) ABSTRACT

This disclosure relates to the field of cooling fans and particularly to a ring-shaped light fan. The ring-shaped light fan includes a frame, and a first receiving chamber and a second receiving chamber disposed at both ends of the frame respectively. The first receiving chamber contains a first fan, the second receiving chamber contains a second fan, and each end point of the frame has a fixing hole. The frame, fixing hole, first receiving chamber and second receiving chamber are integrally formed. The outer periphery of the frame has a light emitting module. With a reasonable design, a light emitting module is mounted around the periphery of the ring-shaped light fan to achieve the ring-shaped lighting effect of the fan.

### FIELD OF INVENTION

The present disclosure relates to the technical field of cooling fans, in particular to a ring-shaped light fan.

### BACKGROUND OF INVENTION

### Description of the Related Art

As computer technologies advance, personal computers have entered into homes and become an indispensable part of our daily life. The mainstream of personal computers has gradually changed from custom machines specified by manufacturers of major brands to DIY personal computers, and the present economic condition allows people to upgrade their personal computers, and there will be more and more DIY and hardware enthusiasts.

Water cooler is a common part used in DIY computer hardware. Water cooling is generally divided into integrated water cooling and split cooling. Compared with the split cooling, the integrated cooling incurs a lower cost. In other words, most personal computers are installed with a water cooler. The integrated water cooler is generally comprised of a cooling system, a fan, a water pipe, and a cold head, and the fan is mounted onto the cooling system for cooling a coolant passing through the cooling system. At present, standard sized light fans are commercially available. Although a light strip may be installed to the fans of this sort, yet the light strip may be hindered by the fixing portions at the four end points of the fan. As a result, the ring-shaped lighting effect cannot be achieved.

### SUMMARY OF THE INVENTION

Therefore, it is a primary objective of this disclosure to overcome the aforementioned drawbacks and deficiencies of the prior art by providing a ring-shaped light fan with a reasonable design, and the fan has a light emitting module installed around the periphery of the fan to achieve the ring-shaped lighting effect.

To achieve the aforementioned and other objectives, this disclosure discloses a ring-shaped light fan comprising a frame and a first receiving chamber disposed at the frame, and the first receiving chamber contains a first fan, and each end point of the frame has a fixing hole, and the frame, the fixing hole and the first receiving chamber are integrally formed, and the outer periphery of the frame has a light emitting module.

Wherein, the light emitting module comprises an LED lamp strip and a lampshade, and the outer periphery of the frame has a groove, and the LED lamp strip is received in the groove, and the lampshade covers the groove.

Wherein, a sealant is disposed between the lampshade and the frame.

Wherein, the ring-shaped light fan further comprises a second receiving chamber and a second fan, and the second fan is received and installed in the second receiving chamber, and the first receiving chamber and the second receiving chamber are disposed at both ends of the frame respectively, and the frame, the first receiving chamber and the second receiving chamber are integrally formed.

Wherein, the first receiving chamber and the second receiving chamber are respectively and symmetrically disposed at both ends of the frame.

Wherein, the ring-shaped light fan further comprises a third receiving chamber and a third fan; the third fan is received and installed in the third receiving chamber; the third receiving chamber is disposed at the frame; and the first receiving chamber, the second receiving chamber, the third receiving chamber, and the frame are integrally formed.

Wherein, the third fan is installed between the first fan and the second fan on the frame.

Wherein, the first fan and the second fan with respect to the third fan are respectively and symmetrically disposed at both ends of the frame.

Wherein, the frame is a square structure, and the fixing holes are disposed at four vertices of the frame respectively.

This disclosure has the following advantages:

The fan can emit ring-shaped light. In the ring-shaped light fan of this disclosure, the four fixing holes formed on the frame are integrated on the frame, and the light emitting module is mounted around the periphery of the frame, so that the frame can be fixed to a cooling system with a standard size without blocking the light emitted from the light emitting module. With a reasonable design, the ring-shaped light fan of this disclosure can avoid the light of the light strip from being blocked by the fixing hole 13, so as to achieve the ring-shaped lighting effect of the fan.

### BRIEF DESCRIPTION OF THE DRAWINGS

FIG. 1 is a perspective view of the structure of this disclosure;

FIG. 2 is another perspective view of the structure of this disclosure; and

FIG. 3 is a cross-sectional view of the structure of this disclosure

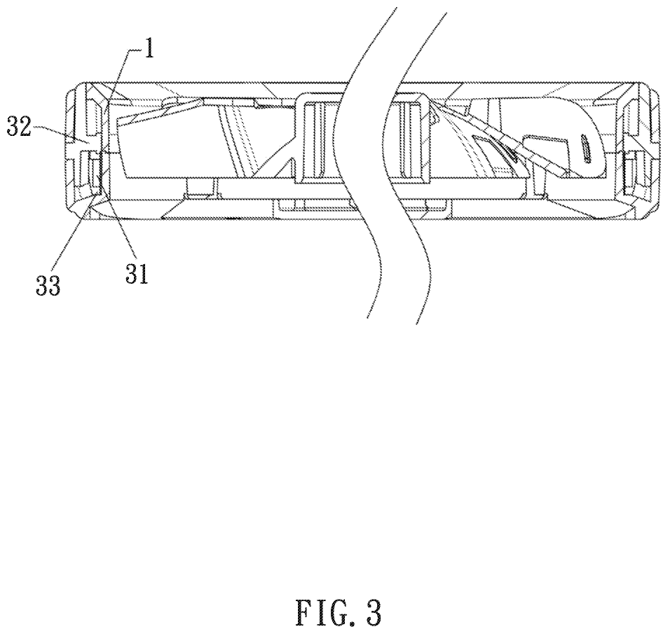

### DESCRIPTION OF THE PREFERRED EMBODIMENTS

The present disclosure will become clearer in light of the following detailed description of an illustrative embodiment of this disclosure described in connection with the drawings, so that people having ordinary skill in the art can implement the present disclosure according to the description of this specification.

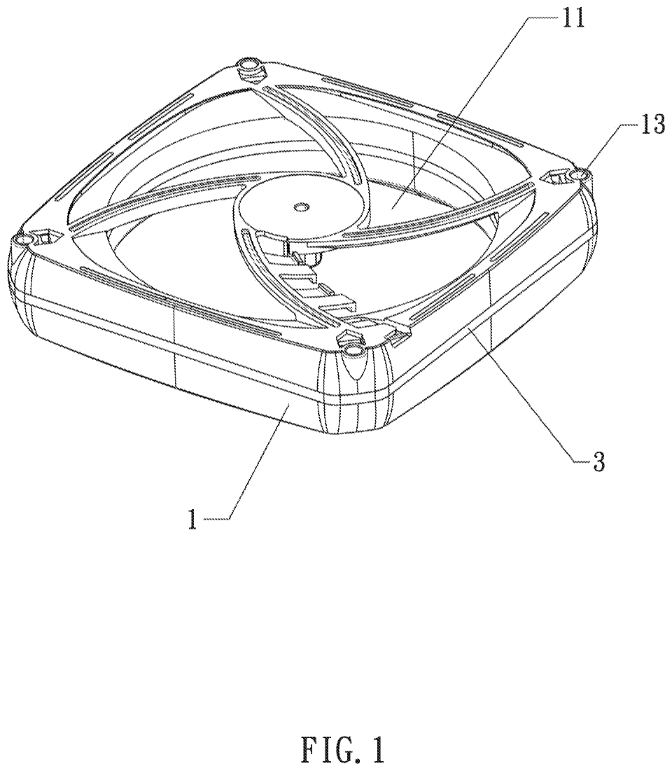

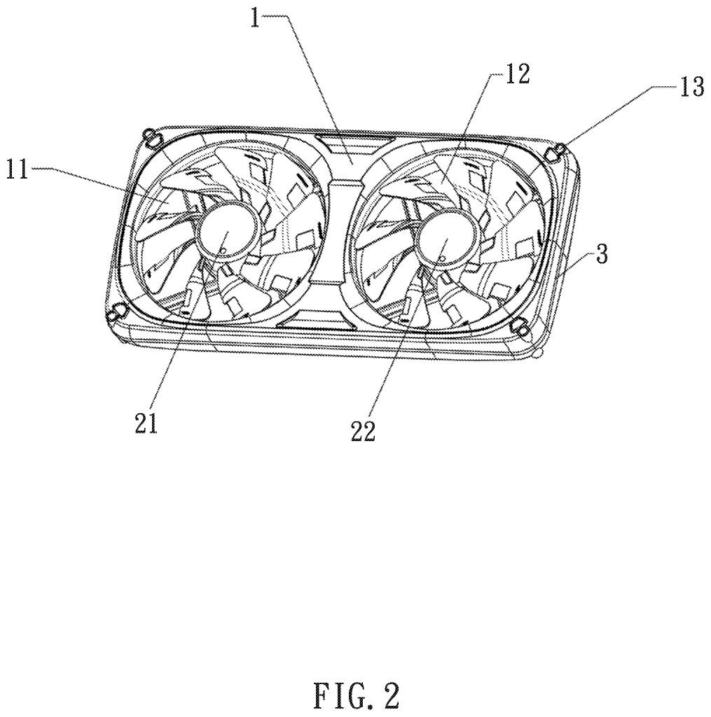

With reference to FIGS. 1 and 2 for a ring-shaped light fan of this disclosure, the ring-shaped light fan comprises a frame 1 and a first receiving chamber 11 disposed at the frame 1, and the first receiving chamber 11 contains a first fan 21, and each end point of the frame 1 has a fixing hole 13, and the frame 1, the fixing hole 13 and the first receiving chamber 11 are integrally formed, and the outer periphery of the frame 1 has a light emitting module 3.

The ring-shaped light fan of this embodiment has the following effects:

The fan can emit a ring-shaped light. In the ring-shaped light fan of this embodiment, four fixing holes 13 are integrated on the frame 1, and the light emitting module 3 is mounted around the periphery of the frame 1, so that the frame 1 can be fixed to a cooling system of a standard size without blocking the light emitted from the light emitting module 3. With a reasonable design, the ring-shaped light fan of this embodiment can avoid the light of the light strip from being blocked by the fixing hole 13, so as to achieve the ring-shaped lighting effect of the fan.

Specifically, the light emitting module 3 comprises an LED lamp strip 31 and a lampshade 32, and the outer periphery of the frame 1 has a groove 33, and the LED lamp strip 31 is received and installed in the groove 33, and the lampshade 32 is covered onto the groove 33. The LED lamp strip 31 is embedded into the groove 33, and the lampshade 32 covers the groove 33 for protecting the LED lamp strip 31. In the meantime, the light emitted from the LED lamp strip 31 can be transmitted to the outside of the fan through the lampshade 32. In this embodiment, the light emitting module 3 is mounted around the frame 1, and the LED lamp strip 31 shows a whole circle of light without having any gap occurred in the light. In this embodiment, the lampshade 32 extends upwardly from the interior of the frame 1 and further extends along a parallel direction and has a portion exposed from the frame 1, so that the light emitted from the LED lamp strip 31 can pass through the lampshade 32, and the light is emitted from both upper and middle rings of the frame 1. In the meantime, the lampshade 32 is made of a fully transparent material or a matte material to achieve different lighting and displaying effects.

In addition, a sealant is disposed between the lampshade 32 and the frame 1. Since a large quantity of dust may be accumulated in the housing of the cooling system after a long time of use, the aforementioned arrangement can improve the sealing effect of the LED lamp strip 31 in the groove 33 and can prevent the dust from entering into the groove 33 which will affect the displaying effect of the LED lamp strip 31.

In general, the size of a single cooling fan is 120 mm or 140 mm. A larger volume of vanes gives rise to a larger energy consumption used for the heat dissipation. The cooling system is generally a form of a cuboid to facilitate its installation in the housing of the main system. In this embodiment, when the frame 1 has just one first receiving chamber 11 and the size of the frame 1 is 120 mm or 140 mm, the ring-shaped light fan may be mounted onto a cooling system having a size of 120 mm or 140 mm.

Specifically, the ring-shaped light fan further comprises a second receiving chamber 12 and a second fan 22, and the second fan 22 is received and installed in the second receiving chamber 12, and the first receiving chamber 11 and the second receiving chamber 12 are disposed at both ends of the frame 1 respectively, and the frame 1, the first receiving chamber 11 and the second receiving chamber 12 are integrally formed. In this embodiment, the first receiving chamber 11 and the second receiving chamber 12 are respectively and symmetrically disposed on both sides of the frame 1. In the meantime, the frame 1 is a square structure, and the fixing holes 13 are disposed at four vertices of the frame 1 respectively. In this embodiment, after the ring-shaped light fan and the cooling system are installed, the assembled fan has a good overall appearance and the fan and the cooling system can have a better combination effect.

The ring-shaped light fan of this embodiment can also be used in a cooling system having the size of 240 mm or 280 mm. It is noteworthy that there are cooling systems having three or more cooling fans, and the size of the cooling system having three cooling fans is 360 mm and 420 mm. Therefore, this embodiment may further comprise a third receiving chamber and a third fan, wherein the third fan is received and installed in the third receiving chamber, and the third receiving chamber is disposed at the frame, and the first receiving chamber 11, the second receiving chamber 12 and the third receiving chamber are integrally formed with the frame 1. Therefore, three fans used for cooling can be fitted into the frame of the size of 360 mm or 420 mm, and the ring-shaped light fan of this embodiment can be mounted onto the cooling system of the size of 360 mm or 420 mm, so as to meet the higher requirements for heat dissipation and power consumption.

Specifically, the third fan is installed between the first fan 21 and the second fan 22 on the frame 1, and the first fan 21 and the second fan 22 with respect to the third fan are respectively and symmetrically disposed at both ends of the frame 1, so that the fan has a good overall appearance as well as a uniform cooling effect of the cooling system.

While the present disclosure has been described by means of specific embodiments, numerous modifications and variations could be made thereto by those skilled in the art without departing from the scope and spirit of this disclosure set forth in the claims

What is claimed is:

1. A ring-shaped light fan, comprising a frame and a first receiving chamber disposed at the frame, and the first receiving chamber containing a first fan, characterized in that each end point of the frame has a fixing hole; the frame, the fixing hole and the first receiving chamber are integrally formed; and the outer periphery of the frame has a light emitting module.

2. The ring-shaped light fan as claimed in claim 1, wherein the light emitting module comprises an LED lamp strip and a lampshade, and the outer periphery of the frame has a groove, and the LED lamp strip is received and installed in the groove, and the lampshade is covered onto the groove.

3. The ring-shaped light fan as claimed in claim 2, further comprising a sealant disposed between the lampshade and the frame.

4. The ring-shaped light fan as claimed in claim 1, further comprising a second receiving chamber and a second fan received and installed in the second receiving chamber, and the first receiving chamber and the second receiving chamber being disposed at both ends of the frame respectively, and the first receiving chamber and the second receiving chamber being integrally formed.

5. The ring-shaped light fan as claimed in claim 4, wherein the first receiving chamber and the second receiving chamber are respectively and symmetrically disposed at both ends of the frame.

6. The ring-shaped light fan as claimed in claim 4, further comprising a third receiving chamber and a third fan received and installed in the third receiving chamber, and the third receiving chamber being disposed at the frame; and the first receiving chamber, the second receiving chamber and the third receiving chamber being integrally formed with the frame.

7. The ring-shaped light fan as claimed in claim 6, wherein the third fan is installed between the first fan and the second fan on the frame.

8. The ring-shaped light fan as claimed in claim 6, wherein the first fan and the second fan with respect to the third fan are respectively and symmetrically disposed at both ends of the frame.

9. The ring-shaped light fan as claimed in claim 1, wherein the frame is a square structure, and the fixing holes are disposed at four vertices of the frame respectively.
